(19) United States
(12) Patent Application Publication
(10) Pub. No.: US 2015/0131099 A1
(43) Pub. Date: May 14, 2015

(54) LIGHT IRRADIATION DEVICE, PARTICLE ANALYSIS DEVICE, AND LIGHT IRRADIATION METHOD

(71) Applicant: Sony Corporation, Tokyo (JP)

(72) Inventor: Katsutoshi Tahara, Tokyo (JP)

(73) Assignee: Sony Corporation, Tokyo (JP)

(21) Appl. No.: 14/528,104

(22) Filed: Oct. 30, 2014

(30) Foreign Application Priority Data
Nov. 14, 2013 (JP) 2013-235762

(51) Int. Cl. G01N 21/49; H05B 37/02

(52) U.S. Cl. CPC G01N 21/49; H05B 37/02
USPC 356/442

(57) ABSTRACT

Provided is a light irradiation device, a particle analysis device, and a light irradiation method, which allow reduction of noise in a signal acquired based on a light emitted from a light-irradiated particle.

The light irradiation device includes: a light irradiator that irradiates irradiation positions different from each other on a flow path through which a particle flows with a plurality of lights corresponding to the irradiation positions, respectively; and a controller that controls light emission from the light irradiator. When the particle having reached an irradiation position of a first light is irradiated with the first light and a signal is acquired based on a light emitted from the particle, the controller makes output of a second light less than output of the second light at acquisition of a signal from the particle by irradiation of the second light.

### CROSS REFERENCE TO RELATED APPLICATIONS

This application claims the benefit of Japanese Priority Patent Application JP 2013-235762 filed on Nov. 14, 2013, the entire contents of which are incorporated herein by reference.

### TECHNICAL FIELD

The present disclosure relates to a light irradiation device, a particle analysis device, and a light irradiation method, more specifically, a light irradiation device, a particle analysis device, and a light irradiation method for irradiating a light to a particle flowing through a flow path.

### BACKGROUND ART

In the related art, in a flow site meter, a plurality of lights may be irradiated to a particle flowing through a flow path (for example, refer to Patent Literature 1).

### CITATION LIST

### Patent Literature

[PTL 1]

JP 11-295208 A

### SUMMARY

### Technical Problem

In the case of irradiating a plurality of lights to a particle, it is desirable that as little noise as possible is contained in a signal acquired based on a light emitted from the particle to which the lights have been irradiated. The present disclosure provides a light irradiation device, a particle analysis device, and a light irradiation method, which allow reduction of noise in a signal acquired based on a light emitted from a light-irradiated particle.

### Solution to Problem

A light irradiation device according to an embodiment of the present disclosure includes: a light irradiator that irradiates irradiation positions different from each other on a flow path through which a particle flows with a plurality of lights corresponding to the irradiation positions, respectively; and a controller that controls light emission from the light irradiator, wherein the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.

The controller may be configured to, before the acquisition of the signal by the irradiation of the first light is started, make the output of the second light less than the output of the second light at signal acquisition by irradiation of the second light. In this case, the controller may be capable of changing starting time of a time period during which the output of the second light is made less than the output of the second light at signal acquisition by irradiation of the second light.

Alternatively, the controller may be capable of changing ending time of a time period during which the output of the second light is made less than the output of the second light at signal acquisition by irradiation of the second light.

Alternatively, the controller may be configured to disable emission of the second light to make the output of the second light less than the output of the second light at signal acquisition by irradiation of the second light.

Alternatively, the second light may include a light shorter in wavelength than the first light. In this case, the second light may include all of lights other than the first light.

The output of the second light at signal acquisition by irradiation of the first light may be made less than the output of the first light.

A particle analysis device according to an embodiment of the present disclosure includes: a light irradiation device having a light irradiator that irradiates irradiation positions different from each other on a flow path through which a particle flows with a plurality of lights corresponding to the irradiation positions, respectively, and a controller that controls light emission from the light irradiator; and a signal acquirer that acquires a signal based on a light emitted from the particle, wherein the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.

In light irradiation method according to an embodiment of the present disclosure, when a particle flowing through a flow path on which a plurality of irradiation positions is set respectively in correspondence with a plurality of lights irradiated from a light irradiator and having reached an irradiation position of a first light is irradiated with the first light and a signal is acquired based on a light emitted from the particle, output of a second light is made less than output of the second light at acquisition of a signal from the particle by irradiation of the second light.

### Advantageous Effects of Invention

According to one embodiment of the present disclosure, it is possible to reduce noise in a signal acquired based on a light emitted from a light-irradiated particle.

### BRIEF DESCRIPTION OF DRAWINGS

FIG. 1 is a diagram schematically showing a configuration example of a particle analysis device of a first embodiment of the present disclosure.

FIG. 2 is a time chart showing an operation example of the particle analysis device of the first embodiment of the present disclosure: FIG. 2A shows output of irradiated lights; and FIG. 2B is a time chart schematically showing acquired signals.

FIG. 3 is a time chart showing an operation example of a particle analysis device of a comparative example of the first embodiment of the present disclosure.

FIG. 4 is a diagram schematically showing a configuration example of a particle analysis device of a first modification example of the first embodiment of the present disclosure.

FIG. 5 is a time chart showing an operation example of the particle analysis device of the first modification example of the first embodiment of the present disclosure: FIG. 5A shows output of irradiated lights; and FIG. 5B is a time chart schematically showing acquired signals.

FIG. 6 is a time chart showing electrical signals of flow path-scattered lights for use in description of an operation example of the particle analysis device of the first modification example of the first embodiment of the present disclosure.

FIG. 7 is a diagram schematically showing a configuration example of a particle analysis device of a second modification example of the first embodiment of the present disclosure.

FIG. 8 is a time chart showing an operation example of the particle analysis device of the second modification example of the first embodiment of the present disclosure: FIG. 8A shows output of irradiated lights; and FIG. 8B is a time chart schematically showing acquired signals.

FIG. 9 is a time chart showing an operation example of a particle analysis device of a second embodiment of the present disclosure: FIG. 9A shows output of irradiated lights; and FIG. 9B is a time chart schematically showing acquired signals.

FIG. 10 is a time chart showing an operation example of a particle analysis device of a first modification example of the second embodiment of the present disclosure: FIG. 10A shows output of irradiated lights; and FIG. 10B is a time chart schematically showing acquired signals.

FIG. 11 is a diagram schematically showing a configuration example of a particle analysis device of a third embodiment of the present disclosure.

FIG. 12 is a time chart showing an operation example of the particle analysis device of the third embodiment of the present disclosure: FIG. 12A is a time chart showing a state before a change is made to starting time of a time period during which output of a second light is made less than output of the second light at signal acquisition by irradiation of the second light; FIG. 12B is a time chart showing a state after a first change; and FIG. 12C is a time chart showing a state after a second change.

FIG. 13 is a time chart showing an operation example of a particle analysis device of a first modification example of the third embodiment of the present disclosure: FIG. 13A shows a state before a change is made to starting time of a time period during which output of a second light is made less than output of the second light at signal acquisition by irradiation of the second light; FIG. 13B shows a state after a first change; and FIG. 13C shows a state after a second change.

FIG. 14 is a time chart showing an operation example of a particle analysis device according to a fourth embodiment of the present disclosure: FIG. 14A shows a state before a change is made to ending time of a time period during which output of a second light is made less than output of the second light at signal acquisition by irradiation of the second light; FIG. 14B shows a state after a first change; and FIG. 14C shows a state after a second change.

FIG. 15 is a time chart showing an operation example of a particle analysis device of a fifth embodiment of the present disclosure: FIG. 15A shows output of irradiated lights; and FIG. 15B is a time chart schematically showing acquired signals.

FIG. 16 is a time chart showing an operation example of a particle analysis device of a sixth embodiment of the present disclosure: FIG. 16A shows output of irradiation lights; and FIG. 16B is a time chart schematically showing an acquired signal.

FIG. 17 is a flowchart showing an operation example of the particle analysis device of the sixth embodiment of the present disclosure.

### DESCRIPTION OF EMBODIMENTS

Preferred modes for carrying out the present disclosure will be described below with reference to the drawings. A plurality of embodiments described below shows mere examples of typical embodiments of the present disclosure, and thus the scope of the present disclosure is not limited by these embodiments. In addition, constitutional elements corresponding to one another in the embodiments will be given the same reference numerals and redundant description thereof will be omitted. The description will be provided in order as follows.

1. First Embodiment

(An example of a particle analysis device in which, at signal acquisition by a first light, output of a second light is made less than output of the second light at signal acquisition time)

2. First Modification Example of First Embodiment

(An example of a particle analysis device that acquires a fluorescent signal)

3. Second modification example of first embodiment

(An example of a particle analysis device to which a plurality of second lights is applied)

4. Second Embodiment

(An example of a particle analysis device that, before start of signal acquisition by a first light, output of a second light is made less than output of the second light at signal acquisition time)

5. First modification example of second embodiment

(An example of a particle analysis device that moderately raises output of a first light)

6. Third Embodiment

(An example of a particle analysis device that is capable of changing starting time of a time period during which output of a second light is made less than output of the second light at signal acquisition time)

7. First modification example of third embodiment

(An example of a particle analysis device that changes the rising speed of output of a first light according to a change in starting time of a time period during which output of a second light is made less than output of the second light at signal acquisition time)

8. Fourth Embodiment

(An example of a particle analysis device that is capable of changing ending time of a time period during which output of a second light is made less than output of the second signal at signal acquisition time)

9. Fifth Embodiment

(An example of a particle analysis device that disables emission of a second light at signal acquisition by a first light)

10. Sixth Embodiment

(An example of a particle analysis device that operates with a detection signal of a sample scattered light as a trigger)

### 1. First Embodiment

### [Configuration Example of Device]

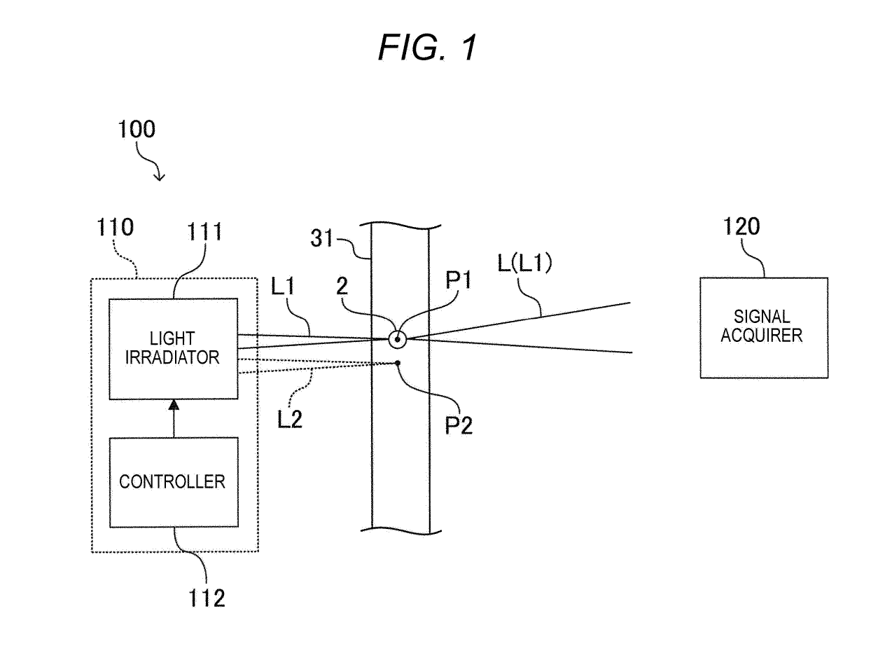

FIG. 1 is a diagram schematically showing a configuration example of a particle analysis device 100 of the present embodiment. As shown in FIG. 1, the particle analysis device 100 roughly includes a light irradiation device 110 and a signal acquirer 120.

### [Light Irradiation Device 110]

The light irradiation device 110 is one embodiment of the light irradiation device according to an embodiment of the present disclosure, and includes a light irradiator 111 and a controller 112.

### [Light Irradiator 111]

As shown in FIG. 1, the light irradiator 111 is configured to irradiate irradiation positions P1 and P2 different from each other on a flow path 31 through which a particle 2 flows with a plurality of lights L1 and L2 corresponding to the irradiation positions P1 and P2, respectively. The irradiation positions P1 and P2 are shifted from each other in the flowing direction of the particle 2. The number of lights irradiated by the light irradiator 111 is not limited to two as shown in FIG. 1 as far as it is more than one. Hereinafter, the n-th (n denotes 1 to the total number of lights) irradiation position from the upstream side in the flowing direction will be defined as an n-th irradiation position, and the light irradiated to the n-th irradiation position will be defined as an n-th light.

The first and second lights L1 and L2 may be lights different in wavelength. The first light L1 may be a light shorter in wavelength than the second light L2. The lights L1 and L2 may be coherent lights excellent in monochromatic, directional, and coherent properties. The coherent lights may be laser lights. The first and second irradiation positions P1 and P2 may be respective focal points of the first and second lights L1 and L2.

There is no limitation on the configuration for shifting the first and second irradiation positions P1 and P2 from each other in the flowing direction of the particle 2. For example, light sources of the lights L1 and L2 may be arranged with a spacing therebetween in the flowing direction. The light irradiator 111 may include an irradiation position adjustment structure to adjust the irradiation positions P1 and P2 of the lights L1 and L2. The irradiation position adjustment structure may include an optical system for focal point adjustment such as a lens or a prism.

There is no limitation on the light sources of the lights L1 and L2. For example, the light sources may be semiconductor lasers, that is, laser diodes, solid-state lasers, gas lasers, or the like. Among them, the semiconductor lasers can be used to configure the device in a small size and at low cost.

### [Controller 112]

The controller 112, that is, the light irradiation control device is configured to control light emission from the light irradiator 111. The controller 112 is configured to, when a particle having reached an irradiation position of a first light is irradiated with the first light and a signal is acquired based on a light emitted from the particle, make output of a second light less than output of the second light at signal acquisition by irradiation of the second light. Here, the output of the second light at signal acquisition by irradiation of the second light refers to output of the second light at acquisition of a signal based on a light emitted from the particle having reached an irradiation position of the second light and having been irradiated with the second light.

Herein, the output of the second light at signal acquisition by irradiation of the second light will be referred to as output of the second light at signal acquisition time.

In the example of FIG. 1, the controller 112 may be configured to, when the particle 2 having reached the first irradiation position P1 is irradiated with the first light L1 and a signal is acquired based on a light emitted from the particle 2, make output of the second light L2 less than the output of the second light L2 at signal acquisition time. The controller 112 may also be configured to, when the particle 2 having reached the second irradiation position P2 is irradiated with the second light L2 and a signal is acquired based on a light emitted from the particle 2, make the output of the first light L1 less than the output of the first light L1 at signal acquisition time.

The controller 112 may be configured to receive input of an external signal indicative of an acquisition state of a signal based on a light emitted from the particle 2. The controller 112 may use the input external signal to control light emission from the light irradiator 111.

The controller 112 may, but not limited to, control output of the lights L1 and L2 by, for example, electrically controlling the light sources of the lights L1 and L2. The controller 112 may be a controller for each light source, that is, a plurality of controllers for controlling independently the respective light sources of the lights L1 and L2, or may be a controller common to the light sources. The controller 112 may be formed by an electronic device or the like. The electronic device may include arithmetic processing units such as a CPU (central processing unit) and an MPU (micro-processing unit), storage devices such as a RAM (random access memory) and a ROM (read only memory), and the like. The ROM may store a light irradiation control program and data for implementing the function of the controller 112. The arithmetic processing unit may execute the program stored in the ROM to implement the function of the controller 112. The RAM may be used as a working area of the arithmetic processing unit or the like. However, the controller 112 is not limited to the configuration described above.

### [Signal Acquirer 120]

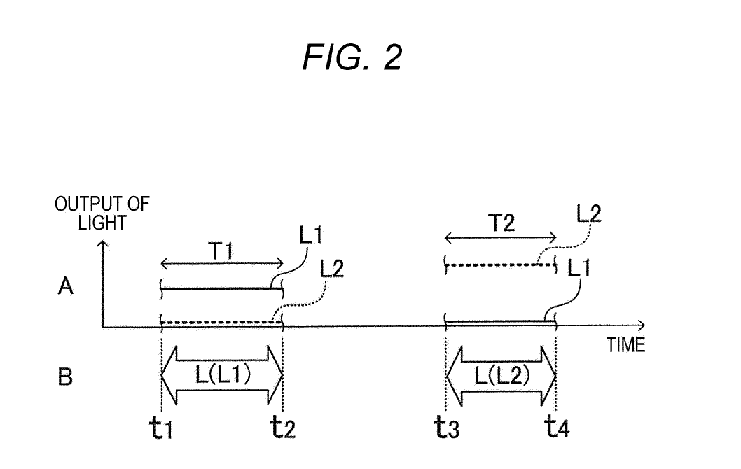

The signal acquirer 120 is configured to acquire signals based on lights L (L1) and L (L2) (refer to FIG. 2B) emitted from the particle 2 by irradiation of the lights L1 and L2. The particle analysis device 100 processes the signals acquired by the signal acquirer 120 to analyze characteristics of the particle 2.

The signal acquirer 120 may be configured to convert the received lights into electrical signals and acquire a signal corresponding to the particle 2, that is, a signal used for analysis of characteristics of the particle 2, from the converted electrical signals. The signal acquirer 120 may be configured to output a signal indicative of the signal acquisition state to the light irradiation device 110.

### [Operation Example of Device]

FIG. 2 is a time chart showing an operation example of the particle analysis device 100 of the present embodiment. The operation example shown in FIG. 2 includes one embodiment of a light irradiation method according to an embodiment of the present disclosure. However, the light irradiation method according to an embodiment of the present disclosure may be embodied by a configuration other than the particle analysis device 100.

In a time period T1 between times t1 and t2 shown in FIG. 2, the particle 2 having reached the first irradiation position P1 is irradiated with the first light L1. Then, the light L (L1) emitted from the particle 2 by the irradiation of the light L1 is received and acquired as a signal by the signal acquirer 120 (refer to FIG. 2B). The acquired signal is used by the particle analysis device 100 for analysis of characteristics of the particle 2 corresponding to the light L (L1).

Here, if the output of the second light L2 is high in the time period T1, a light emitted by irradiating the second light L2 to the flow path 31 may be reflected as a large amount of noise in the signal of the light L (L1) corresponding to the first light L1.

The controller 112 thus treats the first light L1 as a first light and treats the second light L2 as a second light in the time period T1. That is, as shown in FIG. 2A, in the time period T1, the controller 112 controls the output of the second light L2 to be less than the output of the second light L2 at signal acquisition time as output in a time period T2 described later, for example. In the time period T1, the output of the second light L2 may be less than the output of the first light L1.

Next, in the time period T2 between times t3 and t4 shown in FIG. 2, the particle 2 having reached the second irradiation position P2 is irradiated with the second light L2. Then, the light L (L2) emitted from the particle 2 by the irradiation of the light L2 is received and acquired as a signal by the signal acquirer 120 (refer to FIG. 2B). The acquired signal is used by the particle analysis device 100 for analysis of characteristics of the particle 2 corresponding to the light L (L2).

Here, if the output of the first light L1 is high in the time period T2, a light emitted by irradiating the first light L1 to the flow path 31 may be reflected as a large amount of noise in the signal of the light L (L2) corresponding to the second light L2.

Thus, the controller 112 treats the second light L2 as a first light and treats the first light L1 as a second light in the time period T2. That is, as shown in FIG. 2A, in the time period T2, the controller 112 controls the output of the first light L1 to be less than the output of the first light L1 at signal acquisition time as output in the time period T1, for example. In the time period T2, the output of the first light L1 may be less than the output of the second light L2. Note that the relationship in magnitude between the maximum output value of the first light L1 and the maximum output value of the second light L2 is not limited to the relationship in which the second light L2 is larger than the first light L1 as shown in FIG. 2. In addition, there is no limitation on the relationship in magnitude between the minimum output value of the first light L1 and the minimum output value of the second light L2. The relationships in magnitude between the maximum output values of the first light L1 and the second light L2 and between the minimum output values of the same may be reversed from the relationships shown in FIG. 2.

Alternatively, there may be no differences between the output values, that is, the output values may be equal. As described above, in the particle analysis device 100 of the present embodiment, by making the output of the irradiated light at signal acquisition time less than the output of the irradiated light at non-signal acquisition time as shown in FIG. 2, it is possible to reduce noise resulting from the light not contributing to signal acquisition. Accordingly, the S/N ratio (signal-noise ratio) can be improved, which makes it possible to acquire signals with higher precision than those in the past and also improve the precision of analysis of the particle 2.

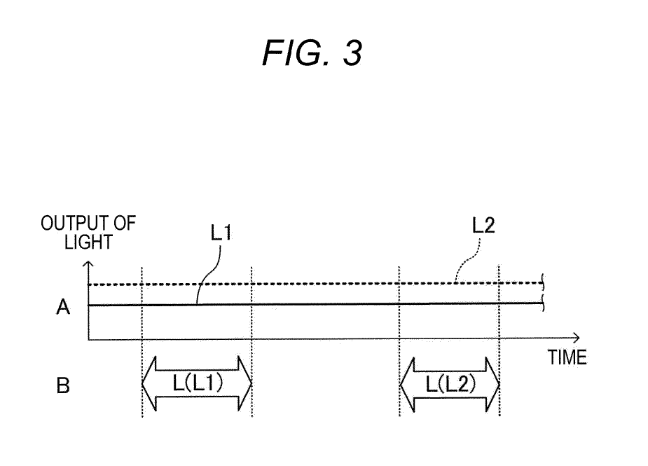

Alternatively, according to the particle analysis device 100 of the present embodiment, the duty ratio can be reduced as compared to that in the case of bringing the state where the output of the lights L1 and L2 is raised, that is, is high at any time as shown in FIG. 3, and thereby it also becomes possible to achieve an improvement in the product lifetime. As in the case where the output of the second light is less than the output of the first light at signal acquisition by the first light or the like, the lower output of the second light allows noise to be further suppressed.

### 2. First Modification Example of First Embodiment

### [Configuration Example of Device]

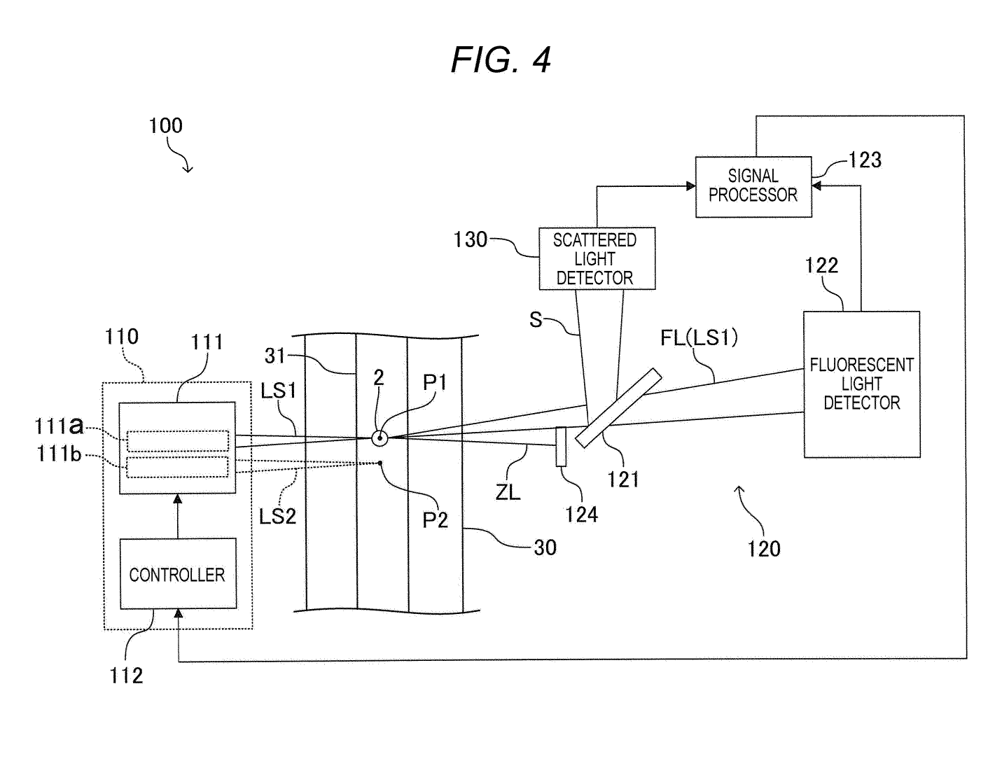

FIG. 4 is an overall view schematically showing a configuration example of a particle analysis device 100 of the present modification example. In the particle analysis device 100 of the present modification example, a signal acquirer 120 is configured to acquire a signal based on a fluorescent light emitted from a particle 2 by irradiation of a laser light. The detailed description will be given below.

### [Light Irradiation Device 110]

### [Light Irradiator 111]

As shown in FIG. 4, a light irradiator 111 of the present modification example has a more specific configuration than the light irradiator 111 shown in FIG. 1, in that a first laser light LS1 is irradiated as a first light and a second laser light LS2 is irradiated as a second light. The first laser light LS1 is irradiated by a first laser light source 111a. The second laser light LS2 is irradiated by a second laser light source 111b. The laser light sources 111a and 111b may be semiconductor lasers or the like. There is no limitation on wavelengths of the laser lights LS1 and LS2, and thus the wavelengths of the laser lights LS1 and LS2 can be selected as appropriate so as to be different from each other. The wavelength of the first laser light LS1 may be about 488 nm corresponding to a blue light, and the wavelength of the second laser light LS2 may be about 638 nm corresponding to a red light. However, the wavelengths are not limited thereto.

### [Controller 112]

The controller 112 may be configured to, when the particle 2 having reached a first irradiation position P1 is irradiated with the first laser light LS1 and a signal is acquired based on a fluorescent light emitted from the particle 2, make output of the second laser light LS2 less than the output of the second laser light LS2 at signal acquisition time. The controller 112 may also be configured to, when the particle 2 having reached a second irradiation position P2 is irradiated with the second laser light LS2 and a signal is acquired based on a fluorescent light emitted from the particle 2, make the output of the first laser light LS1 less than the output of the first laser light LS1 at signal acquisition time.

### [Particle 2]

The particle 2, that is, a microparticle, analyzed by the particle analysis device 100 of the present modification example may include a wide variety of biologically-relevant microparticles such as cells, microorganisms, and ribosomes, synthetic particles such as latex particles, gel particles, and industrial particles, and the like.

The biologically-relevant microparticles may include chromosomes, ribosomes, mitochondria, organelles, that is, cell organelles, and the like, which constitute various cells. In addition, the cells may include plant cells, animal cells, blood cells, and the like. Further, the microorganisms may include germs such as Escherichia coli, viruses such as tobacco mosaic virus, bacteria such as yeast cells, and the like. The biologically-relevant microparticles may also include biologically-relevant polymers such as nucleic acids, proteins, and complexes thereof.

The industrial particles may be particles formed by an organic polymer material, an inorganic material, or a metallic material, or the like. As the organic polymer material, polystyrene, styrene divinylbenzene, polymethylmethacrylate, and the like may be used. As the inorganic material, glass, silica, a magnetic material, and the like may be used. As the metallic material, gold colloid, aluminum, and the like may be used, for example. The shape of the microparticle may be spherical or non-spherical. There is no particular limitation on the size and mass of the microparticle.

There is no limitation on a specific mode of the particle 2 as far as it emits a fluorescent light by irradiation of a laser light. For example, the particle 2 may be multi-stained by fluorescent dyes of excitation wavelengths corresponding to the wavelengths of the laser lights LS1 and LS2, respectively.

### [Flow Path 31]

### [Microchip 30]

As shown in FIG. 4, a flow path 31 is provided on a microchip 30. A sample liquid containing the particle 2 is introduced into the flow path 31. The microchip 30 may be formed by glass or various plastics such as polypropylene, polycarbonate, a cycloolefin polymer, and polydimethylsiloxane. Although there is no particular limitation on a material for the microchip 30, a translucent material with fewer optical errors may be used as one example of a preferable mode.

### [Signal Acquirer 120]

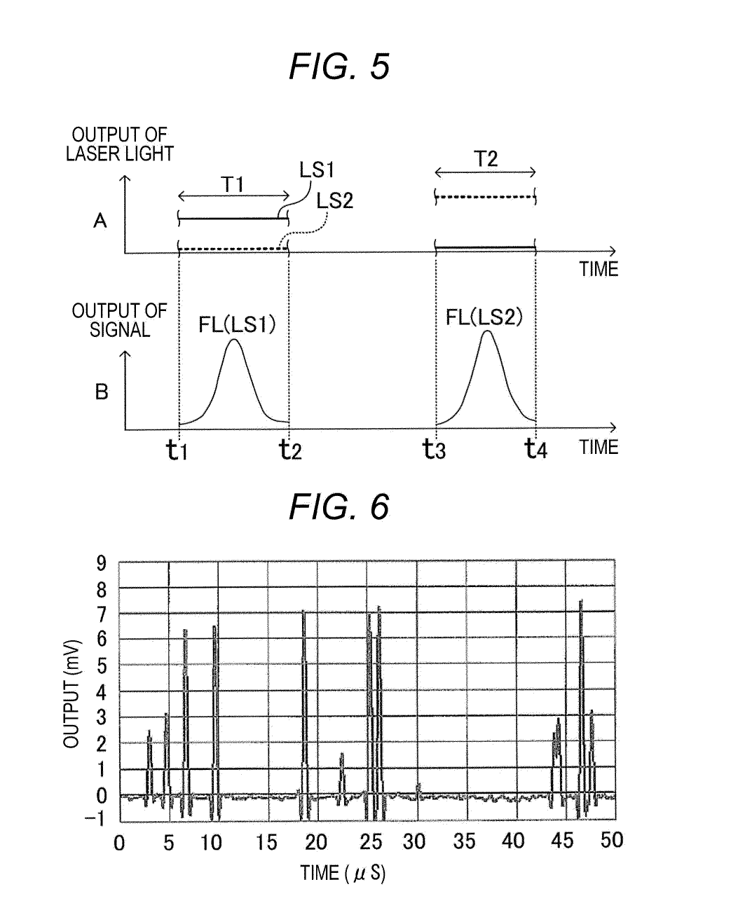

The signal acquirer 120 is configured to acquire signals based on fluorescent lights FL (LS1) and FL (LS2) (refer to FIG. 5B) emitted from the particle 2 by irradiation of the laser lights LS1 and LS2. Although there is no limitation on a mode of the signal acquirer 120, the signal acquirer 120 may include a light separation element 121, a fluorescent light detector 122, and a signal processor 123 as shown in FIG. 4, as one example of a preferable mode. The signal acquirer 120 may further include a zero-order light removal element 124 as shown in FIG. 4.

### [Light Separation Element 121]

The light separation element 121 separates the light emitted from the particle 2 by irradiation of the first laser light LS1 into the fluorescent light FL (LS1) and a scattered light (hereinafter, referred to as a sample scattered light) S, and guides the fluorescent light FL (LS1) to the fluorescent light detector 122. The light separation element 121 may be configured to transmit the fluorescent light FL (LS1) and reflect the sample scattered light S. The light separation element 121 may be configured to separate the fluorescent light FL (LS2) emitted from the particle 2 by irradiation of the second laser light LS2, from the sample scattered light. A plurality of light separation elements 121 may be arranged in correspondence with the laser lights LS1 and LS2, respectively.

The light separation element 121 may be arranged so as to have an inclination with respect to the direction of incidence of a light from the particle 2. The light separation element 121 may be a wavelength-selective mirror or the like that transmits a light with a wavelength equal to or more than a specific wavelength and reflects a light with a wavelength less than the specific wavelength. The mirror may be a dichroic mirror or the like.

### [Fluorescent Light Detector 122]

The fluorescent light detector 122 is arranged on the side in the direction of travel of the fluorescent lights FL (LS1) and FL (LS2) with respect to the light separation element 121. The fluorescent lights FL (LS1) and FL (LS2) enter the fluorescent light detector 122. The fluorescent light detector 122 converts the incident fluorescent lights FL (LS1) and FL (LS2) into electrical signals and outputs the same to the signal processor 123. The fluorescent light detector 122 may be a PMT (photo multiplier tube) or the like.

### [Signal Processor 123]

The signal processor 123 acquires signals corresponding to the particle 2, that is, signals used for analysis of characteristics of the particle 2, from the electrical signals input from the fluorescent light detector 122. The signal processor 123 processes the acquired signals. The processing of the signals may include various kinds of processing for analyzing the characteristics of the particle 2 such as signal quantification, fluorescence correction, and image generation, but is not limited thereto. The signal processor 123 may be formed by an electronic device or the like. The electronic device may include arithmetic processing units such as a CPU and an MPU, storage devices such as a RAM, a ROM, and the like. The ROM may store programs and data for implementing the function of the signal processor 123. The arithmetic processing unit may execute the programs stored in the ROM to implement the function of the signal processor 123. The RAM may be used as a working area in the arithmetic processing unit, or the like. However, the signal processor 123 is not limited to the foregoing configuration.

### [Zero-Order Light Removal Element 124]

The zero-order light removal element 124 shuts off a zero-order light ZL such as the laser light LS1 or LS2 traveling in a straight line without being scattered. The zero-order light removal element 124 may be a mask, an optical filter that selectively shuts off a specific light or the like, but is not limited thereto. There is no limitation on the arrangement position of the zero-order light removal element 124. The zero-order light removal element 124 can be arranged at a position suitably selected in front of the fluorescent light detector 122.

### [Scattered Light Detector 130]

As shown in FIG. 4, the particle analysis device 100 of the present modification example has a scattered light detector 130 at a position on the side in the direction of travel of the sample scattered light S with respect to the light separation element 121. The sample scattered light S separated by the light separation element 121 enters the scattered light detector 130. The scattered light detector 130 converts the incident sample scattered light S into an electrical signal and outputs the same to the signal processor 123. The signal processor 123 processes the electrical signal input from the scattered light detector 130. The scattered light detector 130 may be a photodetector or the like.

### [Operation Example of Device]

FIG. 5 is a time chart showing an operation example of the particle analysis device 100 of the present modification example. The operation example shown in FIG. 5 includes one embodiment of a light irradiation method according to an embodiment of the present disclosure.

In a time period T1 between times t1 and t2 shown in FIG. 5, the particle 2 having reached the first irradiation position P1 is irradiated with the first laser light LS1.

Then, the fluorescent light FL (LS1) emitted from the particle 2 by the irradiation of the laser light LS1 is acquired as a signal by the signal processor 123 (refer to FIG. 5B).

Here, FIG. 6 is a time chart showing one example of output of a PMT in the case where a laser light is irradiated to a liquid flow, that is, a flow path itself, rather than a particle. As shown in FIG. 6, it is understood that the output of the PMT contains spike-like noise. The noise (hereinafter, referred to as scattered noise) is noise resulting from the fact that a scattered light (hereinafter, referred to as a flow path-scattered light) that is caused by irradiation of the laser light to the liquid flow is detected by the PMT. In the case of applying a plurality of laser lights, the flow path-scattered light caused by irradiation of the flow path with a laser light not contributing to signal acquisition may be contained as the scattered noise in a fluorescent light caused by irradiation of the flow path with a laser light contributing to signal acquisition. Incidentally, the flow path-scattered light is a light longer in wavelength than a corresponding laser light. Thus, there is a tendency that, as the laser light corresponding to the fluorescent light has a longer wavelength, a larger number of flow path-scattered lights are caused by other laser lights contained in the fluorescent light. The scattered noise based on the flow path-scattered light may decrease the quality of a fluorescent signal and may deteriorate the evaluation value thereof.

With regard to the example of FIG. 5, if the output of the second laser light LS2 is high in the time period T1, the flow path-scattered light caused by the second laser light LS2 may be reflected as a large amount of the scattered noise in the signal of the fluorescent light FL (LS1) corresponding to the first laser light LS1.

The controller 112 thus treats the first laser light LS1 as a first light and treats the second laser light LS2 as a second light in the time period T1. That is, as shown in FIG. 5A, in the time period T1, the controller 112 controls the output of the second laser light LS2 to be less than the output of the second laser light LS2 at signal acquisition time.

Next, in a time period T2 between times t3 and t4 shown in FIG. 5, the particle 2 having reached the second irradiation position P2 is irradiated with the second laser light LS2. Then, the fluorescent light FL (LS2) emitted from the particle 2 by the irradiation of the laser light LS2 is acquired as a signal by the signal processor 123 (refer to FIG. 5B).

Here, if the output of the first laser light LS1 is high in the time period T2, the flow path-scattered light caused by the first laser light LS1 may be reflected as a large amount of the scattered noise in the signal of the fluorescent light FL (LS2) corresponding to the second laser light LS2.

The controller 112 thus treats the second laser light LS2 as a first light and treats the first laser light LS1 as a second light in the time period T2. That is, as shown in FIG. 5A, in the time period T2, the controller 112 controls the output of the first laser light LS1 to be less than the output of the first laser light LS1 at signal acquisition time.

As described above, in the particle analysis device 100 of the present modification example, by making the output of a laser light at signal acquisition time less than the output of the laser light at non-signal acquisition time as shown in FIG. 5, it is possible to reduce the scattered noise resulting from the laser light not contributing to signal acquisition. This can achieve improvement in the quality and evaluation value of the fluorescent signal. In addition, according to the present modification example, it is possible to make the output of the shorter-wavelength laser light LS1 at signal acquisition by the longer-wavelength laser light LS2 less than the output of the shorter-wavelength laser light LS1 at signal acquisition time. This also allows effective reduction in the scattered noise caused when the shorter-wavelength laser light becomes longer in wavelength. Further, by making the output of all of the laser lights not contributing to signal acquisition less than the output of the respective laser lights at signal acquisition time, it is possible to reduce the scattered noise in a further effective manner.

### 3. Second Modification Example of First Embodiment

### [Configuration Example of Device]

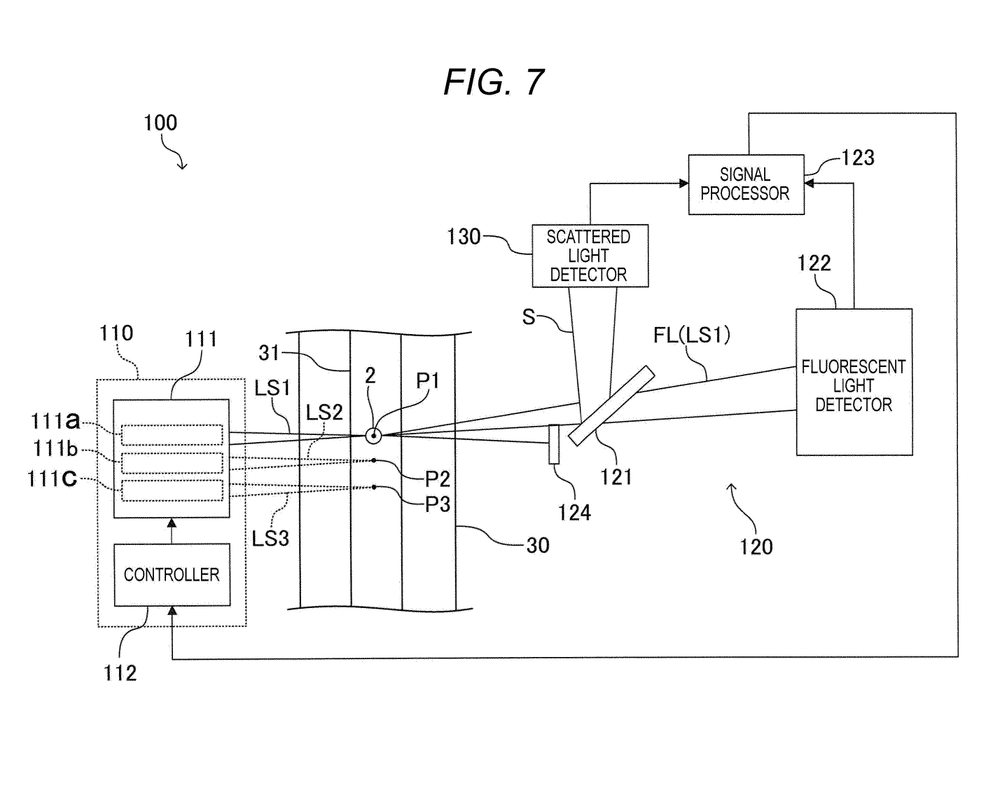

FIG. 7 is an overall view schematically showing a configuration example of a particle analysis device 100 of the present modification example. The particle analysis device 100 of the present modification example is different from the particle analysis device 100 shown in FIG. 4 in the number of laser lights irradiated by a light irradiation device 110. Accordingly, the particle analysis device 100 of the present modification example is also different from the particle analysis device 100 shown in FIG. 4 in specific contents of control by a controller 112. The detailed description will be given below.

### [Light Irradiation Device 110]

### [Light Irradiator 111]

As shown in FIG. 7, a light irradiator 111 of the present modification example is configured to irradiate a third laser light LS3 as well as first and second laser lights LS1 and LS2. The third laser light LS3 is irradiated by a third laser light source 111c. The third laser light LS3 is irradiated to a third irradiation position P3 downstream of a second irradiation position P2. The third laser light L3 is different in wavelength from the first and second laser lights LS1 and LS2. The third laser light LS3 may be a laser light longer in wavelength than the first and second laser lights LS1 and LS2, but the third laser light LS3 is not limited thereto.

### [Controller 112]

The controller 112 may, when a particle 2 having reached the first irradiation position P1 is irradiated with the first laser light LS1 and a signal is acquired based on a fluorescent light emitted from the particle 2, make the output of the second and third laser lights LS2 and LS3 less than the output of the laser lights LS2 and LS3 at signal acquisition time. The controller 112 may also, when the particle 2 having reached the second irradiation position P2 is irradiated with the second laser light LS2 and a signal is acquired based on a fluorescent light emitted from the particle 2, make the output of the first and third laser lights LS1 and LS3 less than the output of the laser lights LS1 and LS3 at signal acquisition time. Further, the controller 112 may also, when the particle 2 having reached the third irradiation position P3 is irradiated with the third laser light LS3 and a signal is acquired based on a fluorescent light emitted from the particle 2, make the output of the first and second laser lights LS1 and LS2 less than the output of the laser lights LS1 and LS2 at signal acquisition time.

### [Operation Example of Device]

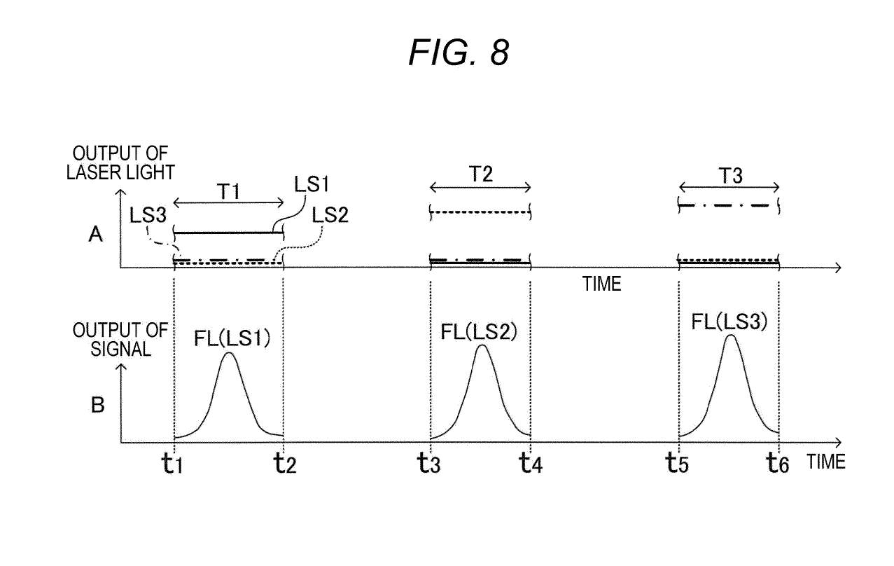

FIG. 8 is a time chart showing an operation example of the particle analysis device 100 of the present modification example. The operation example shown in FIG. 8 includes one embodiment of a light irradiation method according to an embodiment of the present disclosure.

In a time period T1 between times t1 and t2 shown in FIG. 8, the particle 2 having reached the first irradiation position P1 is irradiated with the first laser light LS1. Accordingly, a fluorescent light FL (LS1) emitted from the particle 2 is acquired as a signal by a signal processor 123 (refer to FIG. 8B). The controller 112 treats the first laser light LS1 as a first light and treats the second and third laser lights LS2 and LS3 as a second light in the time period T1. That is, as shown in FIG. 8A, in the time period T1, the controller 112 controls the output of the second laser light LS2 to be less than the output of the second laser light LS2 at signal acquisition time as output in a time period T2 described later, for example. In addition, in the time period T1, the controller 112 controls the output of the third laser light LS3 to be less than the output of the third laser light LS3 at signal acquisition time as output in a time period T3 described later, for example.

Next, in the time period T2 between times t3 and t4 shown in FIG. 8, the particle 2 having reached the second irradiation position P2 is irradiated with the second laser light LS2. Accordingly, a fluorescent light FL (LS2) emitted from the particle 2 is acquired as a signal by the signal processor 123 (refer to FIG. 8B). The controller 112 treats the second laser light LS2 as a first light and treats the first and third laser lights LS1 and LS3 as a second light in the time period T2. That is, as shown in FIG. 8A, in the time period T2, the controller 112 controls the output of the first laser light LS1 to be less than the output of the first laser light LS1 at signal acquisition time as output in the time period T1, for example. In addition, in the time period T2, the controller 112 controls the output of the third laser light LS3 to be less than the output of the third laser light LS3 at signal acquisition time.

Next, in the time period T3 between times t5 and t6 shown in FIG. 8, the particle 2 having reached the third irradiation position P3 is irradiated with the third laser light LS3. Accordingly, a fluorescent light FL (LS3) emitted from the particle 2 is acquired as a signal by the signal processor 123 (refer to FIG. 8B). The controller 112 treats the third laser light LS3 as a first light and treats the first and second laser lights LS1 and LS2 as a second light in the time period T3. That is, as shown in FIG. 8A, in the time period T3, the controller 112 controls the output of the first laser light LS1 to be less than the output of the first laser light LS1 at signal acquisition time. In addition, in the time period T3, the controller 112 controls the output of the second laser light LS2 to be less than the output of the second laser light LS2 at signal acquisition time.

According to the particle analysis device 100 of the present modification example, it is possible to produce the same advantages as those of the particle analysis device 100 shown in FIG. 4 or it is possible to increase the number of analysis targets, that is, fluorescent lights, while maintaining the high precision of analysis.

### 4. Second Embodiment

### [Configuration Example of Device]

A particle analysis device 100 of the present embodiment is different in the configuration of a controller 112 from the particle analysis devices 100 shown in FIGS. 4 and 7.

Specifically, the controller 112 of the present embodiment is configured to, before acquisition of a fluorescent signal by a signal acquirer 120 is started, make the output of a second light less than the output of the second light at signal acquisition time.

### [Operation Example of Device]

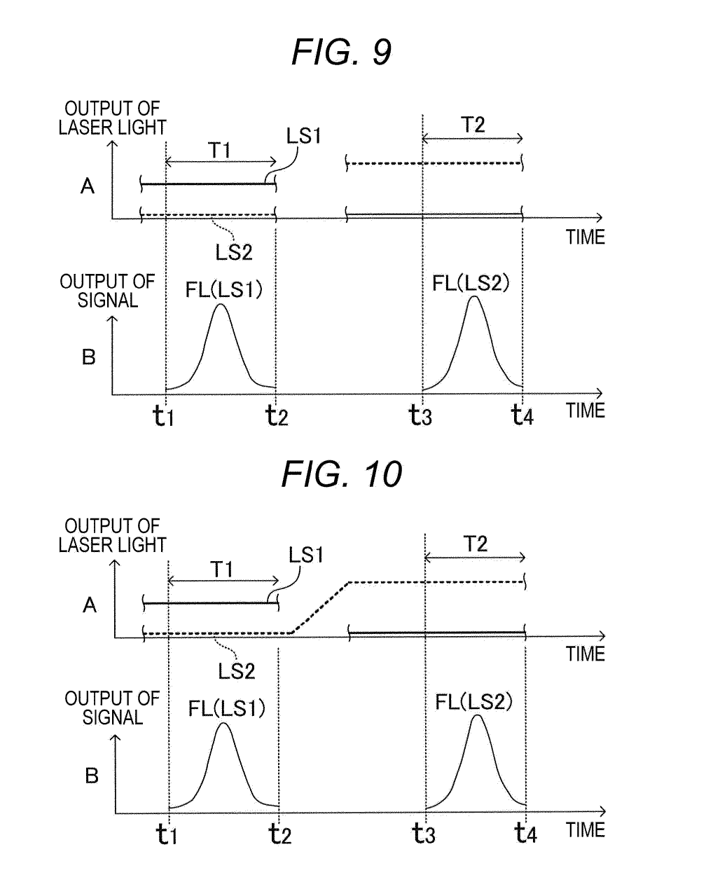

FIG. 9 is a time chart showing an operation example of the particle analysis device 100 of the present embodiment. The operation example shown in FIG. 9 includes one embodiment of a light irradiation method according to an embodiment of the present disclosure.

As compared to FIG. 5, the time chart shown in FIG. 9 specifies that, before start of a time period T1, the output of a second laser light LS2 is controlled to be less than the output of the second laser light LS2 at signal acquisition time. As compared to FIG. 5, FIG. 9 specifies that, before start of a time period T2 and after end of the time period T1, the output of a first laser light LS1 is controlled to be less than the output of the first laser LS1 light at signal acquisition time.

According to the particle analysis device 100 of the present embodiment, it is possible to produce the same advantages as those of the particle analysis devices 100 shown in FIGS. 4 and 7. Alternatively, it is possible to bring a state where the output of the second light has been already lowered at the point of time when acquisition of a signal by a first light is started, which makes it possible to suppress effectively flow-path scattered noise as compared to the case where the output of the second light is lowered after acquisition of a signal by the first light is started.

### 5. First Modification Example of Second Embodiment

### [Configuration Example of Device]

A particle analysis device 100 of the present modification example is different in the configuration of a controller 112 from the particle analysis device 100 described above with reference to FIG. 9.

Specifically, the controller 112 of the present modification example is configured to moderately raise, that is, increase the output of a first light.

### [Operation Example of Device]

FIG. 10 is a time chart showing an operation example of the particle analysis device 100 of the present modification example. The operation example shown in FIG. 10 includes one embodiment of a light irradiation method according to an embodiment of the present disclosure.

As compared to FIG. 9, the time chart shown in FIG. 10 specifies that raising of the output, that is, a shift from the minimum output value to the maximum output value of a second laser light LS2 before start of a time period T2 takes place moderately over a certain time.

According to the particle analysis device 100 of the present modification example, it is possible to produce the same advantages as those of the particle analysis device 100 shown in FIG. 9, or it is possible to reduce EMI (electro-magnetic interference) noise.

### 6. Third Embodiment

### [Configuration Example of Device]

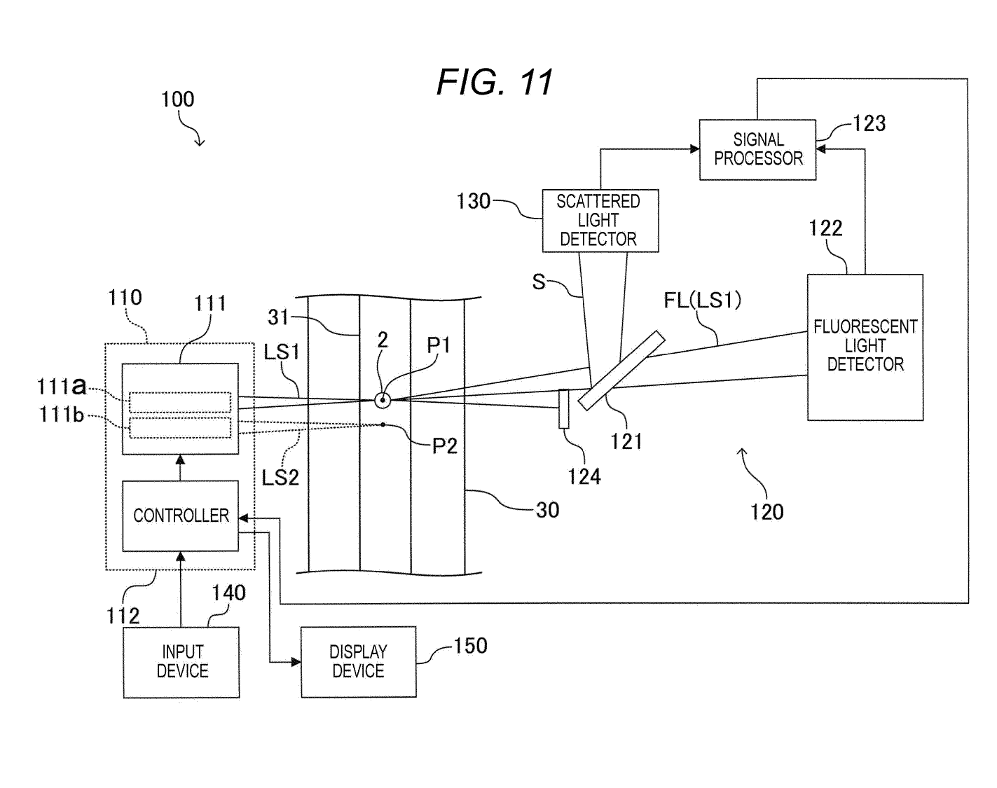

FIG. 11 is an overall view schematically showing a configuration example of a particle analysis device 100 of the present embodiment. The particle analysis device 100 of the present embodiment is different in the configuration of a controller 112 and the like from the particle analysis device 100 of the second embodiment.

Specifically, the controller 112 of the present embodiment is configured to be capable of changing starting time of a time period during which the output of a second light is made less than the output of the second light at signal acquisition time. There is no limitation on the specific configuration for the controller 112 to change the starting time of the time period during which the output of the second light is made less than the output of the second light at signal acquisition time. For example, the controller 112 may control the starting time of the time period during which the output of the second light is made less than the output of the second light at signal acquisition time to be a value according to an input signal from an input device 140. The controller 112 may also cause a display device 150 to display a setting screen for setting the starting time of the time period during which the output of the second light is made less than the output of the second light at signal acquisition time, and receive input from the input device 140. Alternatively, the controller 112 may set automatically the starting time of the time period during which the output of the second light is made less than the output of the second light at signal acquisition time. The automatic setting may be made based on already acquired information such as the flow rate of a sample liquid or the like, and may also be embodied as a new function added to publicly-known functions of automatically setting up sample measurement conditions. However, the automatic setting is not limited to these modes.

### [Operation Example of Device]

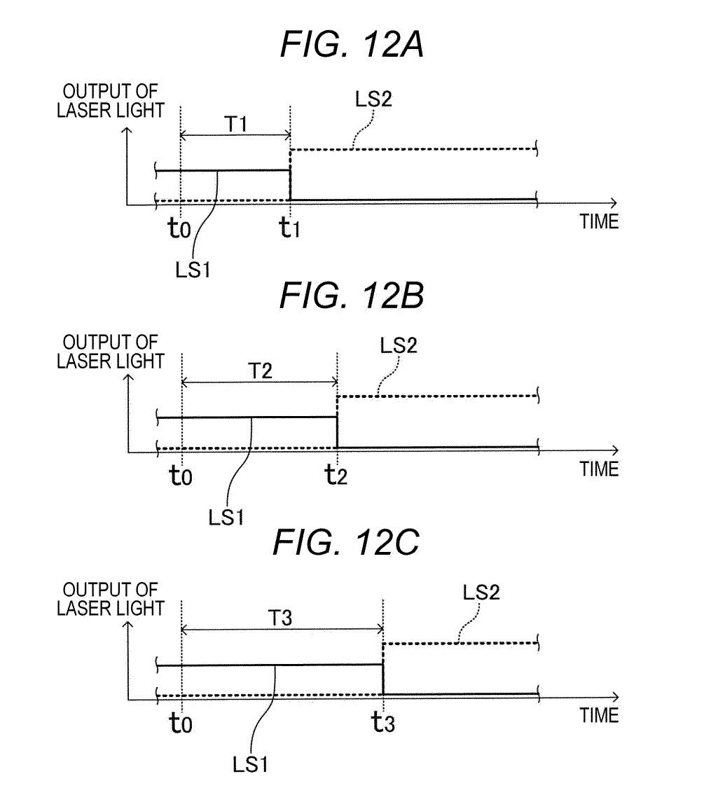

FIG. 12 is a time chart showing an operation example of the particle analysis device 100 of the present embodiment. The operation example shown in FIG. 12 includes one embodiment of a light irradiation method according to an embodiment of the present disclosure.

First, FIG. 12A shows an output state in the case where the staring time of the time period during which the output of the second light is made less than the output of the second light at signal acquisition time is set to a time t1 at which a time period T1 has elapsed since a reference time t0. In FIG. 12, a first light is defined as a first light with reference to a second irradiation position P2, that is, a second laser light LS2, and the second light is defined as a second light with reference to the second irradiation position P2, that is, a first laser light LS1. That is, FIG. 12A shows the output state in the case where the starting time of the time period during which the output of the first laser light LS1 is made less than the output of the first laser light LS1 at signal acquisition time is set to the time t1.

There is no limitation on the mode of the reference time t0. For example, the reference time t0 may be a time at which the acquisition of a signal by the first laser light LS1 is started, that is, a time at which the acquisition of a signal by the second light is started. The time period T1 may be an acquisition time period of a signal by the first laser light LS1, that is, a gate time period corresponding to the first laser light LS1, but the time period T1 is not limited thereto. In addition, falling of output of the first laser light LS1 may take place concurrently with raising of output of the second laser light LS2 as shown in FIG. 12, or may take place before the raising of output of the second laser light LS2.

Next, when detecting an input signal specifying a time period T2 larger than the time period T1, the controller 112 changes the starting time of the time period during which the output of the second light is made less than the output of the second light at signal acquisition time, to a time t2 at which the time period T2 has elapsed since the reference time t0 as shown in FIG. 12B.

In addition, when detecting an input signal specifying a time period T3 larger than the time period T2, the controller 112 changes the starting time of the time period during which the output of the second light is made less than the output of the second light at signal acquisition time, to a time t3 at which the time period T3 has elapsed since the reference time t0 as shown in FIG. 12C.

For such input values T2 and T3 for changing the starting time, it is desirable to set upper and lower limits so that the starting time after the change does not fall within the signal acquisition time period.

According to the particle analysis device 100 of the present embodiment, it is possible to produce the same advantages as those of the particle analysis device 100 of the second embodiment, or it is possible to improve the degree of freedom of the mode of light output control.

### 7. First Modification Example of Third Embodiment

### [Configuration Example of Device]

A particle analysis device 100 of the present modification example is different in the configuration of a controller 112 from the particle analysis device 100 shown in FIG. 11.

Specifically, the controller 112 of the present modification example is configured to change the rising speed of the output of a first light along with a change in starting time of a time period during which the output of a second light is made less than the output of the second light at signal acquisition time.

### [Operation Example of Device]

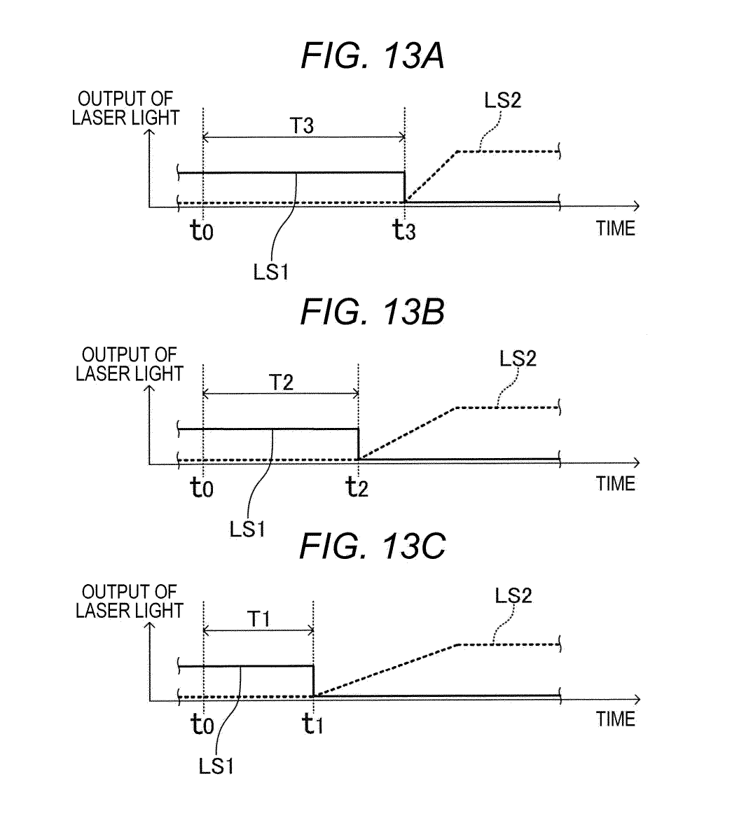

FIG. 13 is a time chart showing an operation example of the particle analysis device 100 of the present modification example. The operation example shown in FIG. 13 includes one embodiment of a light irradiation method according to an embodiment of the present disclosure.

First, FIG. 13A shows an output state in the case where the starting time of the time period during which the output of the second light is made less than the output of the second light at signal acquisition time is set to a time t3 at which a time period T3 has elapsed since a reference time t0. Here, in FIG. 13, as in FIG. 12, a first light is defined as a second laser light LS2, and the second light is defined as a first laser light LS1. In the state shown in FIG. 13A, the rising speed of the output of the first light LS2 is set to a somewhat slow speed by the controller 112. That is, in the state of FIG. 13A, the rising waveform of the output of the first light LS2 is set to a somewhat moderate waveform. The moderate waveform forms an upward slope with a gradually increase of output over time in FIG. 13A, but is not limited thereto.

Next, when detecting an input signal specifying a time period T2 smaller, that is, shorter than the time period T3, the controller 112 changes the starting time of the time period during which the output of the second light is made less than the output of the second light at signal acquisition time, to a time t2 at which the time period T2 has elapsed since the reference time t0 as shown in FIG. 13B. At that time, the controller 112 changes the rising speed of the output of the first light LS2 to a speed further slower than that shown in FIG. 13A.

Next, when detecting an input signal specifying a time period T1 smaller than the time period T2, the controller 112 changes the starting time of the time period during which the output of the second light is made less than the output of the second light at signal acquisition time, to a time t1 at which the time period T1 has elapsed since the reference time t0 as shown in FIG. 13C. At that time, the controller 112 changes the rising speed of the output of the first light LS2 to a speed further slower than that shown in FIG. 13B.

According to the particle analysis device 100 of the present modification example, it is possible to produce the same advantages as those of the particle analysis device 100 of the second embodiment, or it is possible to realize output control more suitable for reduction of EMI noise.

### 8. Fourth Embodiment

### [Configuration Example of Device]

A particle analysis device 100 of the present embodiment is different in the configuration of a controller 112 from the particle analysis devices 100 of the first to third embodiments.

Specifically, the controller 112 of the present embodiment is configured to be capable of changing ending time of a time period during which the output of a second light is made less than the output of the second light at signal acquisition time. There is no limitation on the specific configuration for the controller 112 to change the ending time of the time period during which the output of the second light is made less than the output of the second light at signal acquisition time. For example, the configuration for changing the starting time of the time period during which the output of the second light is made less than the output of the second light at signal acquisition time has been described in the third embodiment, but the same configuration may be employed in the present embodiment.

### [Operation Example of Device]

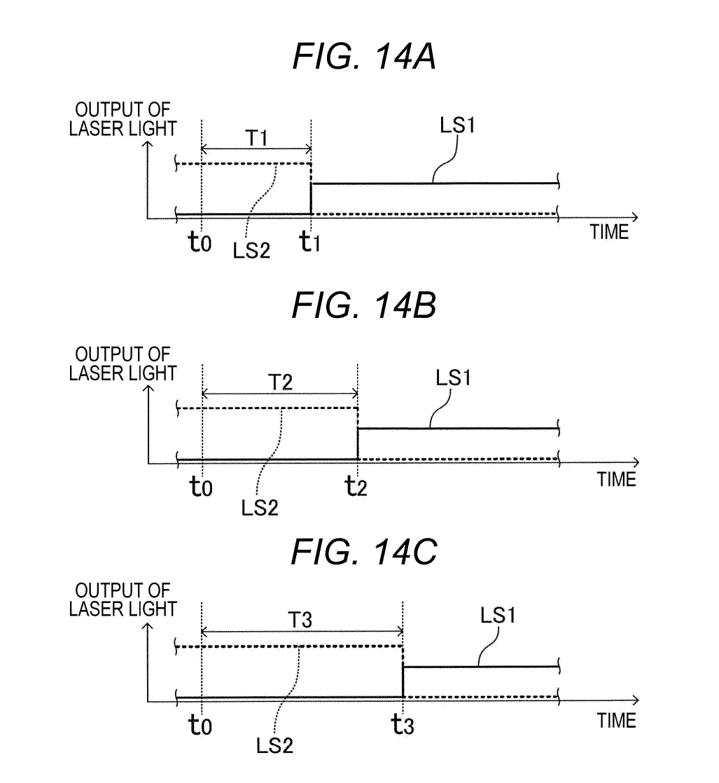

FIG. 14 is a time chart showing an operation example of a particle analysis device 100 of the present embodiment. The operation example shown in FIG. 14 includes one embodiment of a light irradiation method according to an embodiment of the present disclosure.

First, FIG. 14A shows an output state in the case where the ending time of the time period during which the output of the second light is made less than the output of the second light at signal acquisition time is set to a time t1 at which a time period T1 has elapsed since a reference time t0. Here, in FIG. 14, as in FIG. 12, a first light is defined as a second laser light LS2, and the second light is defined as a first laser light LS1. The reference time t0 may be a time at which the acquisition of a signal by the second laser light LS2 is started, that is, a time at which the acquisition of a signal by the first light is started. The time period T1 may be an acquisition time period of a signal by the second laser light LS2, that is, a gate time period corresponding to the second laser light LS2, but the time period T1 is not limited thereto. In addition, raising of output of the first laser light LS1 may take place concurrently with falling of output of the second laser light LS2 as shown in FIG. 14, or may take place after the falling of output of the second laser light LS2.

Next, when detecting an input signal specifying a time period T2 larger than the time period T1, the controller 112 changes the ending time of the time period during which the output of the second light is made less than the output of the second light at signal acquisition time, to a time t2 at which the time period T2 has elapsed since the reference time t0 as shown in FIG. 14B.

In addition, when detecting an input signal specifying a time period T3 larger than the time period T2, the controller 112 changes the ending time of the time period during which the output of the second light is made less than the output of the second light at signal acquisition time, to a time t3 at which the time period T3 has elapsed since the reference time t0 as shown in FIG. 14C.

Note that the controller 112 may control the output of the first light such that, as there is a delay in the ending time of the time period during which the output of the second light is made less than the output of the second light at signal acquisition time, the falling speed of the first light (LS2 in FIG. 14) becomes gradually slower.

According to the present embodiment, it is possible to produce the same advantages as those of the particle analysis devices 100 of the first to third embodiments, or it is possible to keep the output of the laser light raised for abort processing or the like even after the signal acquisition, and thereby it is possible to improve the degree of freedom of signal processing. Note that, when a new signal is acquired within the duration of raising of the output of the laser light after the signal acquisition, a signal processor 123 may delete signals before and after the acquisition, that is, both of the events, or may delete either of them.

### 9. Fifth Embodiment

### [Configuration Example of Device]

A particle analysis device 100 of the present embodiment is different in the configuration of a controller 112 from the particle analysis devices 100 of the first to fourth embodiments.

Specifically, the controller 112 of the present embodiment is configured to disable emission of a second light to make the output of the second light less than the output of the second light at signal acquisition time.

### [Operation Example of Device]

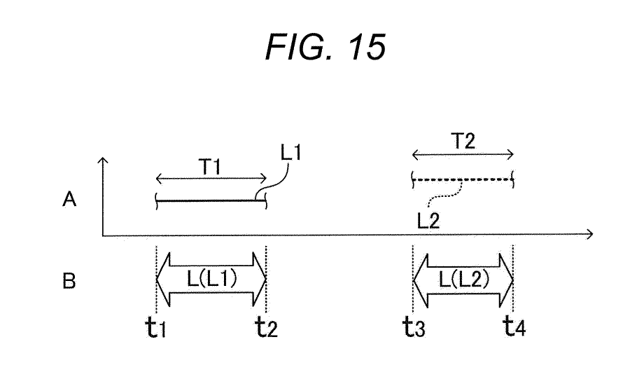

FIG. 15 is a time chart showing an operation example of the particle analysis device 100 of the present embodiment. The operation example shown in FIG. 15 includes one embodiment of a light irradiation method according to an embodiment of the present disclosure.

In a time period T1 between times t1 and t2 shown in FIG. 15, a particle 2 having reached a first irradiation position P1 is irradiated with a first light L1. Then, a light L (L1) emitted from the particle 2 by the irradiation of the light L1 is received and acquired as a signal by a signal acquirer 120. The controller 112 treats the first light L1 as a first light and treats a second light L2 as a second light in the time period T1. That is, as shown in

FIG. 15A, the controller 112 disables emission of the second light L2 in the time period T1.

Next, in a time period T2 between times t3 and t4 shown in FIG. 15, the particle 2 having reached a second irradiation position P2 is irradiated with the second light L2. Then, a light L (L2) emitted from the particle 2 by the irradiation of the light L2 is received and acquired as a signal by the signal acquirer 120. The controller 112 treats the second light L2 as a first light and treats the first light L1 as a second light in the time period T2. That is, as shown in FIG. 15A, the controller 112 disables emission of the first light L1 in the time period T2.

As described above, in the particle analysis device 100 of the present embodiment, by disabling the emission of an irradiated light not contributing to the signal acquisition as shown in FIG. 15, it is possible to reduce noise resulting from the irradiated light not contributing to the signal acquisition in a further effective manner.

### 10. Sixth Embodiment

A particle analysis device 100 of the present embodiment is specified in the configurations of a light irradiator 111, a signal acquirer 120, and a controller 112, as compared to the particle analysis device 100 shown in FIG. 4.

Specifically, the light irradiator 111 of the present embodiment is configured to irradiate a blue laser light as a first laser light, and irradiate a red laser light as a second laser light.

In addition, the signal acquirer 120 is configured to trigger acquisition of a fluorescent signal according to a signal of a sample scattered light corresponding to the blue laser light detected by a scattered light detector 130. The controller 112 is further configured to use the trigger as a reference for the time of laser light output control. The controller 112 may be configured to be notified of the detection of the trigger by the signal acquirer 120, that is, a signal processor 123. The notification may be made by signal input. The signal processor 123 and the controller 112 may be configured to measure the time elapsed since the detection of the trigger. This configuration may be embodied by including a time measurer such as a timer in the signal processor 123 and the controller 112, but is not limited thereto.

### [Operation Example of Device]

### [Time Chart]

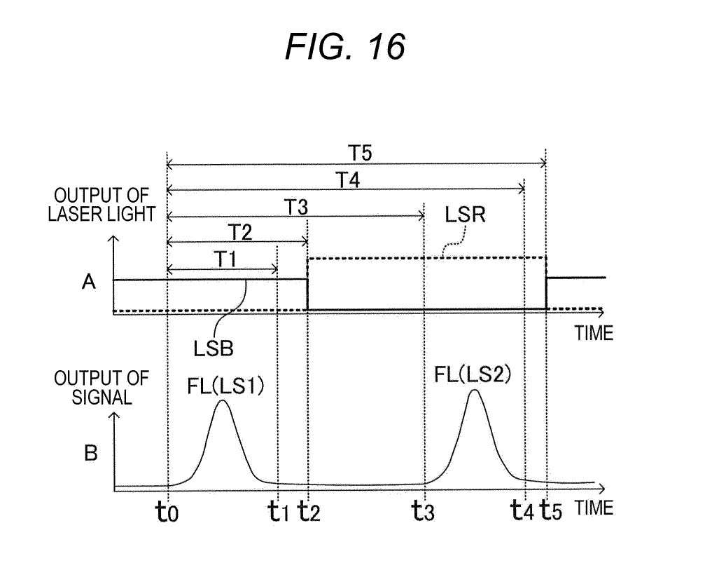

FIG. 16 is a time chart showing an operation example of the particle analysis device 100 of the present embodiment. The operation example shown in FIG. 16 includes one embodiment of a light irradiation method according to an embodiment of the present disclosure.

In the present embodiment, as shown in the left end of FIG. 16, the output of a blue laser light LSB is raised from the start of the processing, and the output of a red laser light LSR is made less than the output of the laser light LSR at signal acquisition time, and then arrival of a particle 2 at a irradiation position of the blue laser light LSB is waited for. At that time, the emission of the red laser light LSR itself may be disabled.

Next, when the particle 2 have reached the irradiation position of the blue laser light LSB at a time to, a sample scattered light emitted from the particle 2 irradiated with the blue laser light LSB is detected and converted into an electrical signal by the scattered light detector 130. When the electrical signal is detected as a trigger by the signal processor 123, the signal processor 123 opens a gate. Accordingly, the signal processor 123 starts acquisition of a fluorescent signal corresponding to the blue laser light LSB input from a fluorescent light detector 122, that is, acquisition of a signal used for analysis of characteristics.

Next, when a preset time period T1 has elapsed since the time t0 at which the trigger was detected and then a time t1 has been reached, the signal processor 123 terminates the acquisition of the signal based on the blue laser light LSB.

Next, when a preset time period T2 has elapsed since the time t0 and a time t2 has been reached, the controller 112 controls the output of the blue laser light LSB to be less than the output of the blue laser light LSB at signal acquisition time. The time period T2 may be identical to the time period T1.

Next, a preset time period T3 (>T1 and T2) has elapsed since the time t0 and a time t3 has been reached, the signal processor 123 starts acquisition of a fluorescent signal corresponding to the red laser light LSR input from the fluorescent light detector 122.

Next, when a preset time period T4 (>T3) has elapsed since the time t0 and a time t4 has been reached, the signal processor 123 terminates the acquisition of the signal based on the red laser light LSR.

Next, when a preset time period T5 has elapsed since the time t0 and a time t5 has been reached, the controller 112 controls the output of the red laser light LSR to be less than the output of the red laser light LSR at signal acquisition time. The time period T5 may be identical to the time period T4.

### [Flowchart]

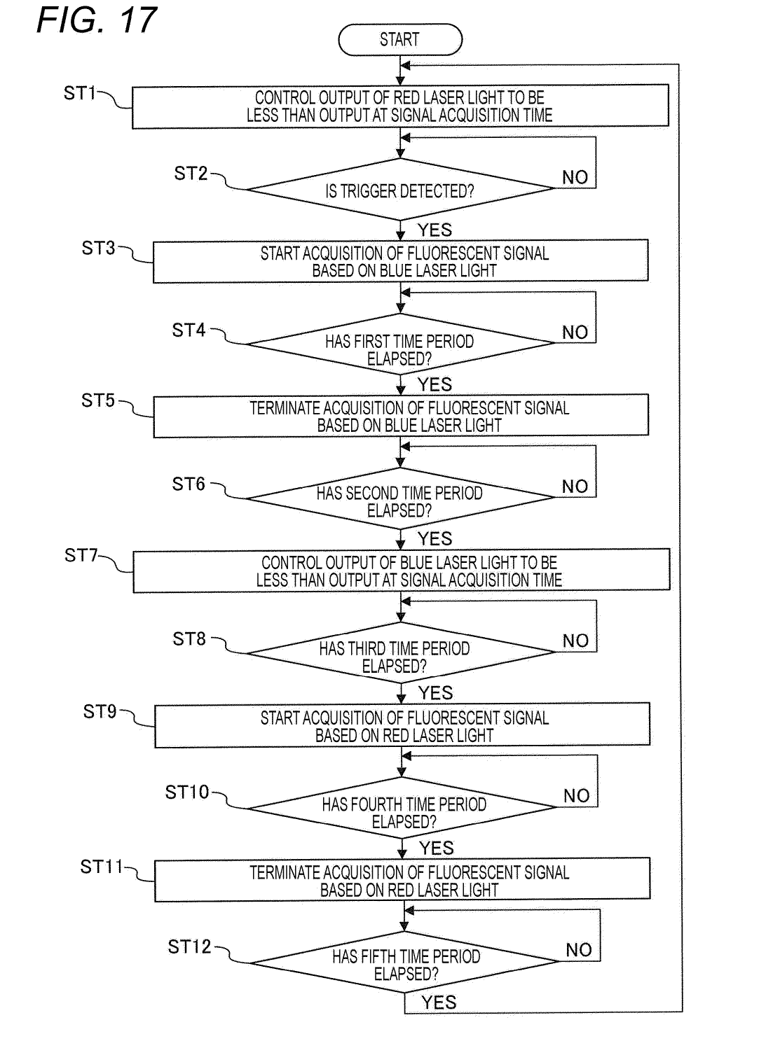

FIG. 17 is a flowchart showing an operation example of the particle analysis device 100 of the present embodiment.

Referring to FIG. 17, first, at step 1 (S1), the controller 112 controls the output of the red laser light to be less than the output of the red laser light at signal acquisition time.

Next, at step 2 (S2), the signal processor 123 determines whether a trigger based on the sample scattered light of the blue laser light is detected. Then, when the determination result is affirmative, the process proceeds to step 3 (S3), and when the determination result is negative, the process returns to step 2 (S2).

Next, at step 3 (S3), the signal processor 123 starts acquisition of the fluorescent signal based on the blue laser light.

Next, at step 4 (S4), the signal processor 123 determines whether the first time period has elapsed since the detection of the trigger. Then, when the determination result is affirmative, the process proceeds to step 5 (S5), and when the determination result is negative, the process returns to step 4 (S4).

Next, at step 5 (S5), the signal processor 123 terminates the acquisition of the fluorescent signal based on the blue laser light.

Next, at step 6 (S6), the signal processor 123 determines whether the second time period has elapsed since the detection of the trigger. Then, when the determination result is affirmative, the process proceeds to step 7 (S7), and when the determination result is negative, the process returns to step 6 (S6).

Next, at step 7 (S7), the controller 112 controls the output of the blue laser light to be less than the output of the blue laser light at signal acquisition time.

Next, at step 8 (S8), the signal processor 123 determines whether the third time period has elapsed since the detection of the trigger. Then, when the determination result is affirmative, the process proceeds to step 9 (S9), and when the determination result is negative, the process returns to step 8 (S8).

Next, at step 9 (S9), the signal processor 123 starts the acquisition of the fluorescent signal based on the red laser light.

Next, at step 10 (S10), the signal processor 123 determines whether the fourth time period has elapsed since the detection of the trigger. Then, when the determination result is affirmative, the process proceeds to step 11 (S11), and when the determination result is negative, the process returns to step 10 (S10).

Next, at step 11 (S11), the signal processor 123 terminates the acquisition of the fluorescent signal based on the red laser light.

Next, at step 12 (S12), the signal processor 123 determines whether the fifth time period has elapsed since the detection of the trigger. Then, when the determination result is affirmative, the process proceeds to step 1 (S1), and when the determination result is negative, the process returns to step 12 (S12). The particle analysis device 100 may repeat the foregoing series of steps until a trigger for termination of measurement is detected.

According to the particle analysis device 100 of the present embodiment, it is possible to perform control of output of the laser lights and acquisition of signals based on a common reference, that is, a common trigger, and thereby it is possible to simplify control.

The foregoing embodiments and modification examples may be combined as appropriate.

The advantages described in the embodiments and modification examples are mere examples and are not limited. There may be other advantages. The present disclosure may produce any one of the plurality of advantages described in the embodiments and modification examples.

In addition, the present disclosure can include the following configurations.

(1) A light irradiation device including:
a light irradiator that irradiates irradiation positions different from each other on a flow path through which a particle flows with a plurality of lights corresponding to the irradiation positions, respectively; and
a controller that controls light emission from the light irradiator, wherein
the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.
(2) The light irradiation device according to (1),
wherein the controller is configured to, before the acquisition of the signal by the irradiation of the first light is started, make the output of the second light less than the output of the second light at signal acquisition by irradiation of the second light.
(3) The light irradiation device according to (2),
wherein the controller is capable of changing starting time of a time period during which the output of the second light is made less than the output of the second light at signal acquisition by irradiation of the second light.
(4) The light irradiation device according to any of (1) to (3), wherein the controller is capable of changing ending time of a time period during which the output of the second light is made less than the output of the second light at signal acquisition by irradiation of the second light.
(5) The light irradiation device according to any of (1) to (4), wherein the controller is configured to disable emission of the second light to make the output of the second light less than the output of the second light at signal acquisition by irradiation of the second light.
(6) The light irradiation device according to any of (1) to (5), wherein the second light includes a light shorter in wavelength than the first light.
(7) The light irradiation device according to (6),
wherein the second light includes all of lights other than the first light.
(8) The light irradiation device according to any of (1) to (7), wherein the output of the second light at signal acquisition by irradiation of the first light is made less than the output of the first light.
(9) A particle analysis device including:
a light irradiation device having a light irradiator that irradiates irradiation positions different from each other on a flow path through which a particle flows with a plurality of lights corresponding to the irradiation positions, respectively, and a controller that controls light emission from the light irradiator; and
a signal acquirer that acquires a signal based on a light emitted from the particle, wherein
the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.
(10) A light irradiation method, wherein when a particle flowing through a flow path on which a plurality of irradiation positions is set respectively in correspondence with a plurality of lights irradiated from a light irradiator and having reached an irradiation position of a first light is irradiated with the first light and a signal is acquired based on a light emitted from the particle, output of a second light is made less than output of the second light at acquisition of a signal from the particle by irradiation of the second light.

### REFERENCE SIGNS LIST

110 Light irradiation device
111 Light irradiator
112 Controller
2 Particle
31 Flow path

1. A light irradiation device comprising:
a light irradiator that irradiates irradiation positions different from each other on a flow path through which a particle flows with a plurality of lights corresponding to the irradiation positions, respectively; and
a controller that controls light emission from the light irradiator, wherein
the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.

2. The light irradiation device according to claim 1, wherein the controller is configured to, before the acquisition of the signal by the irradiation of the first light is started, make the output of the second light less than the output of the second light at signal acquisition by irradiation of the second light.

3. The light irradiation device according to claim 2, wherein the controller is capable of changing starting time of a time period during which the output of the second light is made less than the output of the second light at signal acquisition by irradiation of the second light.

4. The light irradiation device according to claim 1, wherein the controller is capable of changing ending time of a time period during which the output of the second light is made less than the output of the second light at signal acquisition by irradiation of the second light.

5. The light irradiation device according to claim 1, wherein the controller is configured to disable emission of the second light to make the output of the second light less than the output of the second light at signal acquisition by irradiation of the second light.

6. The light irradiation device according to claim 1, wherein the second light includes a light shorter in wavelength than the first light.

7. The light irradiation device according to claim 6, wherein the second light includes all of lights other than the first light.

8. The light irradiation device according to claim 1, wherein the output of the second light at signal acquisition by irradiation of the first light is made less than the output of the first light.

9. A particle analysis device comprising:
a light irradiation device having a light irradiator that irradiates irradiation positions different from each other on a flow path through which a particle flows with a plurality of lights corresponding to the irradiation positions, respectively, and a controller that controls light emission from the light irradiator; and
a signal acquirer that acquires a signal based on a light emitted from the particle, wherein
the controller is configured to, when the particle having reached an irradiation position of a first light is irradiated with the first light and a signal is acquired based on a light emitted from the particle, make output of a second light less than output of the second light at acquisition of a signal from the particle by irradiation of the second light.

10. A light irradiation method, wherein when a particle flowing through a flow path on which a plurality of irradiation positions is set respectively in correspondence with a plurality of lights irradiated from a light irradiator and having reached an irradiation position of a first light is irradiated with the first light and a signal is acquired based on a light emitted from the particle, output of a second light is made less than output of the second light at acquisition of a signal from the particle by irradiation of the second light.
